(19) United States
(12) Patent Application Publication
(10) Pub. No.: US 2017/0015161 A1
(43) Pub. Date: Jan. 19, 2017

(54) ATTACHMENT APPARATUS FOR SECURING IMPLEMENTS TO A VEHICLE

(71) Applicant: David Earle GRANT, Old Town, ME (US)

(72) Inventor: David Earle GRANT, Old Town, ME (US)

(21) Appl. No.: 15/206,177

(22) Filed: Jul. 8, 2016

Related U.S. Application Data
(60) Provisional application No. 62/193,428, filed on Jul. 16, 2015.

(51) Int. Cl. B60D 1/173; B60D 1/42

(52) U.S. Cl. CPC B60D 1/173; B60D 1/42

(57) ABSTRACT

An adapter to be used with a vehicle having a movable two point connection means, whereby the adapter serves to secure various implements to the movable connection means such that movement of the two point connection means results in movement of the implement relative to the vehicle.

### CROSS REFERENCE TO RELATED APPLICATION

This application claims the benefit of provisional application, U.S. Ser. No. 62/193,428, filed Jul. 16, 2015 and currently pending, entitled ATTACHMENT APPARATUS FOR SECURING IMPLEMENTS TO A VEHICLE, by David E. Grant, which is hereby incorporated by reference.

### BACKGROUND OF THE INVENTION

The present invention relates to an apparatus adapted to be used with a vehicle having a movable two point connection means, whereby said apparatus serves to secure various implements to said movable connection means.

A two point connection means, whereby the implement is connected to the vehicle at two distinct points located apart from each other, provides greater stability than a one point connection means (such as may be found in a conventional trailer hitch). It also allows for different degrees of motion of the implement relative to the vehicle, including lateral motion of the implement relative to the vehicle. Thus, for example, a vehicle carrying a snowplow blade having a two point connection means can not only plow snow located directly in front of it, but it can also position the plow to extend laterally to either side of the vehicle to allow for plowing to the side of the vehicle. Similarly, a vehicle carrying lifting forks need not align directly behind the object to be lifted if the lifting forks can be moved laterally to the side to reach the object.

Notwithstanding the foregoing, an implement which is attached to a vehicle using a two point connection means at a fixed point will have limited relative movement. That is, if the two point connection means has a maximum lateral travel of four feet, for example, the implement can be extended at most four feet beyond the vehicle. However, if the implement can be attached to the vehicle at multiple points, it is possible to allow for an offset connection, thereby allowing for greater extension of the implement laterally beyond the maximum lateral travel of the two point connection means. Using the above example, if the implement is attached off center by two feet, the implement can be extended as much as six feet beyond the vehicle.

The two point connection means, in connection with the implement, defines a certain geometry relative to the vehicle. In one embodiment the implement, the two point connection means, and the vehicle define a rectangle. In this configuration, lateral movement of the two point connection means creates a parallelogram and moves the implement perpendicular to the vehicle. In another embodiment, the two point connection means, and the vehicle define an isosceles trapezoid. In this configuration, lateral movement of the two point connection means creates an asymmetric trapezoid and moves the implement in an arc relative to the vehicle. In yet another embodiment, the two point connection means, and the vehicle define a reverse isosceles trapezoid. In this configuration, lateral movement of the two point connection means creates an asymmetric trapezoid and moves the implement in a reverse arc relative to the vehicle. Having a fixed attachment point between the two point connection means and the implement, however, results in only one of the foregoing geometries being available.

What is needed, then, is a two point connection means that can be repositioned relative to the implement to allow for offset attachment as well as differing connection geometries.

It is thus an object of the present invention to provide an adapter to be used to attach an implement to a two point connection means.

It is a further object of the present invention to provide an adapter which can be attached to a two point connection means are differing points to allow for offset connection of an implement.

It is yet a further object of the present invention to provide an adapter which can be attached to a two point connection means are differing points to allow for differing connection geometries.

Other objects of the present invention will be readily apparent from the description that follows.

### SUMMARY OF THE INVENTION

The present invention is adapted to be used with a movable two point connection means of a vehicle. Such a movable two point connection means is disclosed in U.S. Pat. No. 8,734,082, “Implement Support Device”, issued to David E. Grant on May 27, 2014 (the “'082 Patent”). The Implement Support Device of the '802 Patent is adapted to be attached to the undercarriage of a vehicle and comprises an implement support structure, with the implement support structure having a pair of support arms extending from the undercarriage of the vehicle, a lift mechanism adapted to raise and lower the support arms, and a swing mechanism adapted to move the support arms laterally. See '082 Patent, claim 1. When mounted to a vehicle, the Implement Support Device may be used to support and manipulate useful implements, such as a snowplow blade, a pair of fork lift forks, a container, a platform, and the like.

The apparatus of the present invention is an adapter which serves as an interface between the support arms of the Implement Support Device of the '802 Patent and an implement. The adapter is pivotally attached to the support arms of the Implement Support Device. The adapter may be removably attachable to the implement or it may be fixedly attached to the implement; in either case, during use the adapter remains in fixed relation to the implement.

Depending on where the support arms of the Implement Support Device of the '802 Patent are pivotally attached to the adapter, lateral movement of the support arms results in a concurrent relative repositioning of the adapter relative to the support arms, and thus a concurrent relative repositioning of the implement attached to the adapter relative to the vehicle.

When the adapter is used in a first mode, the support arms pivotally attach to the adapter in a manner that results in the support arms being substantially parallel to each other. See FIG. 1A. In said first mode, lateral movement of the support arms causes the adapter to move laterally in a linear path substantially perpendicular to the longitudinal axis of the vehicle. See FIG. 1B.

When the adapter is used in a second mode, the support arms pivotally attach to the adapter in a manner whereby the ends of the support arms distal from the vehicle are farther apart then the ends of the support arms proximate to the vehicle. See FIG. 2A. In said second mode, lateral movement of the support arms causes the adapter to move laterally in an arcing movement, with the arc substantially convex in relation to the vehicle. See FIG. 2B.

When the adapter is used in a third mode, the support arms pivotally attach to the adapter in a manner whereby the ends of the support arms distal from the vehicle are closer together then the ends of the support arms proximate to the vehicle. See FIG. 3A. In said third mode, lateral movement of the support arms causes the adapter to move laterally in an arcing movement, with the arc substantially concave in relation to the vehicle. See FIG. 3B.

Within the foregoing three modes, the support arms may be pivotally attached to the adapter at differing points, thereby allowing for different positions of the implement relative to the vehicle and/or different radii of the arcs defined by movement of the adapter in the second and third modes. See FIGS. 4A, 4B, and 4C.

It is to be understood that the foregoing and following description of the invention is intended to be illustrative and exemplary rather than restrictive of the invention as claimed. These and other aspects, advantages, and features of the invention will become apparent to those skilled in the art after review of the entire specification, accompanying figures, and claims incorporated herein.

### DESCRIPTION OF THE DRAWINGS

FIG. 1A depicts the adapter of the present invention attached to the support arms of the Implement Support Device of the '802 Patent in a first mode. Portions of the support arms hidden by the vehicle and by the adapter are shown in ghost lines.

FIG. 1B depicts the adapter of the present invention of FIG. 1A as it is moved laterally to the right by the support arms of the Implement Support Device of the '802 Patent. Portions of the support arms hidden by the vehicle and by the adapter are shown in ghost lines.

FIG. 2A depicts the adapter of the present invention attached to the support arms of the Implement Support Device of the '802 Patent in a second mode. Portions of the support arms hidden by the vehicle and by the adapter are shown in ghost lines.

FIG. 2B depicts the adapter of the present invention of FIG. 2A as it is moved laterally to the right by the support arms of the Implement Support Device of the '802 Patent. The path of the adapter defines a convex arc relative to the vehicle. Portions of the support arms hidden by the vehicle and by the adapter are shown in ghost lines.

FIG. 3A depicts the adapter of the present invention attached to the support arms of the Implement Support Device of the '802 Patent in a third mode. Portions of the support arms hidden by the vehicle and by the adapter are shown in ghost lines.

FIG. 3B depicts the adapter of the present invention of FIG. 3A as it is moved laterally to the right by the support arms of the Implement Support Device of the '802 Patent. The path of the adapter defines a concave arc relative to the vehicle. Portions of the support arms hidden by the vehicle and by the adapter are shown in ghost lines.

FIG. 4A depicts the adapter of the present invention attached to the support arms of the Implement Support Device of the '802 Patent in a first mode, whereby the attachment points are shifted to allow the adapter to extend to the left relative to the vehicle. Portions of the support arms hidden by the vehicle and by the adapter are shown in ghost lines.

FIG. 4B depicts the adapter of the present invention attached to the support arms of the Implement Support Device of the '802 Patent in a second mode, whereby the attachment points are shifted to allow the adapter to extend to the left relative to the vehicle. Portions of the support arms hidden by the vehicle and by the adapter are shown in ghost lines.

FIG. 4C depicts the adapter of the present invention attached to the support arms of the Implement Support Device of the '802 Patent in a third mode, whereby the attachment points are shifted to allow the adapter to extend to the left relative to the vehicle. Portions of the support arms hidden by the vehicle and by the adapter are shown in ghost lines.

FIG. 5 depicts the adapter of the present invention attached to the support arms of the Implement Support Device of the '802 Patent in a first mode, with an implement attached to the adapter. In this embodiment the adapter is angled to accommodate an angled implement, in this case a snowplow. Portions of the support arms hidden by the vehicle and by the adapter are shown in ghost lines.

FIG. 6 depicts the adapter of the present invention whereby the attachment component is comprised of a cross piece, two pivot arms, and four pivot pins.

FIG. 7 depicts the configuration shown in FIG. 6 with a towing vehicle making a turn and the towed vehicle following.

FIG. 8 depicts another embodiment of the adapter of the present invention whereby the pivot means moves laterally within the support member. Components hidden within the support member are shown in gray.

### DESCRIPTION OF THE PREFERRED EMBODIMENTS OF THE INVENTION

The present invention comprises an adapter 100 to be used with a two point connection means 30 and an implement 20. The two point connection means 30 is adapted to be used with a vehicle 10, such as an automobile or a light truck. It is adapted to be attached to the undercarriage of the vehicle 10 and comprises an implement support structure. The implement support structure itself has a pair of support arms 32 which extend from the undercarriage of the vehicle 10. It also has a lift mechanism adapted to raise and lower the support arms 32, and a swing mechanism adapted to move the support arms 32 laterally. The two point connection means 30 may extend from the front of the vehicle 10, for example, to be used with a snow plow 20, or a bucket, or a forklift, or it may extend from the rear of the vehicle 10, for example, to be used with a trailer, a roller, or a the like. These and other implements are supported by the two point connection means 30.

The adapter 100 of the present invention serves as the interface between the two point connection means 30 and the implement 20. It allows the implement 20 to be positioned in multiple different ways with respect to the two point connection means 30, thereby increasing the utility of the implement 20.

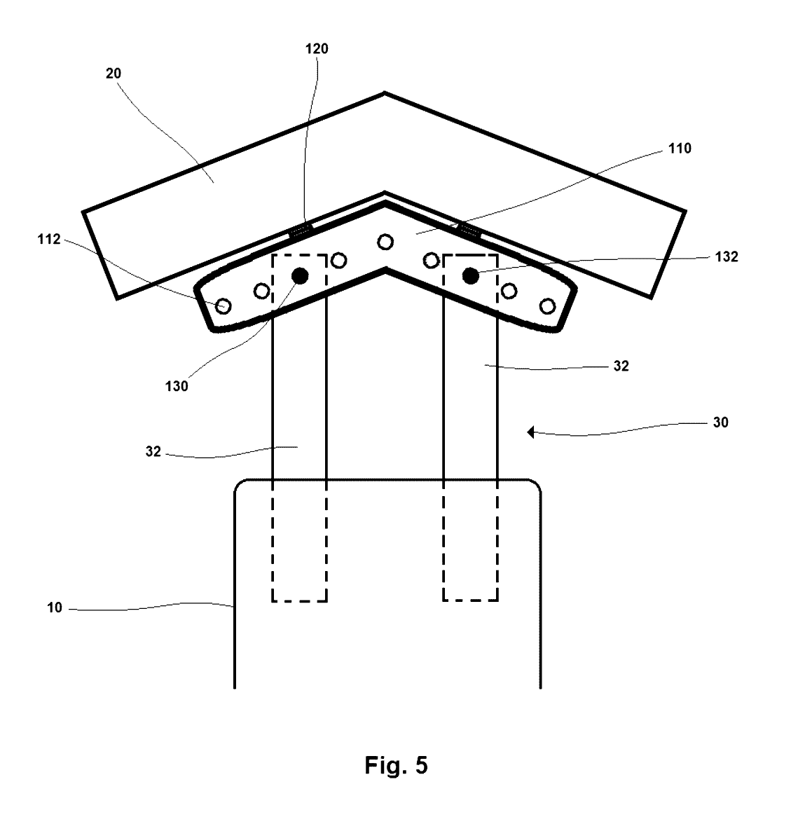

The adapter 100 comprises a support member 110, an attachment component 120, and a pair of pivot means 130. The support member 110 is substantially rigid and of sufficient structural strength to bear the weight of the implement 20. It may be made of steel, iron, an alloy, or any other suitable material. The support member 110 is generally elongate and oriented substantially horizontally, though other configurations are also contemplated. In one embodiment the support member 110 is a length of channel iron. The support member 110 may be a unitary structure or it may be made of multiple components. In one embodiment the support member 110 is comprised of a first arm and a second arm, with the first arm oriented at an angle to the second arm. The two arms may be attached to each other or spaced apart from each other. This configuration is useful when the implement 20 is a v-plow. See FIG. 5.

The attachment component 120 of the adapter 100 is configured to attach the support member 110 of the adapter 100 to the implement 20. There may be one or more subcomponents of the attachment component 120. The attachment component 120 may be as simple as one or more welds, fixedly attaching the support member 110 to the implement 20. The attachment component 120 may also be a plurality of fasteners, such as nuts and bolts, or key-in-slot configurations adapted to fit the implement 20. Any means known in the art to securely retain the implement 20 to the support member 110 may be used for the attachment component 120, whether the attachment is permanent or removable.

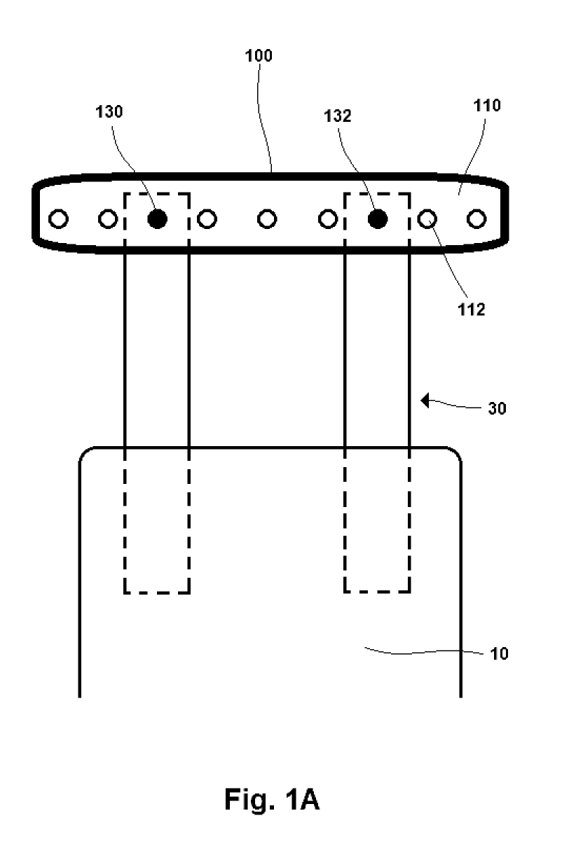

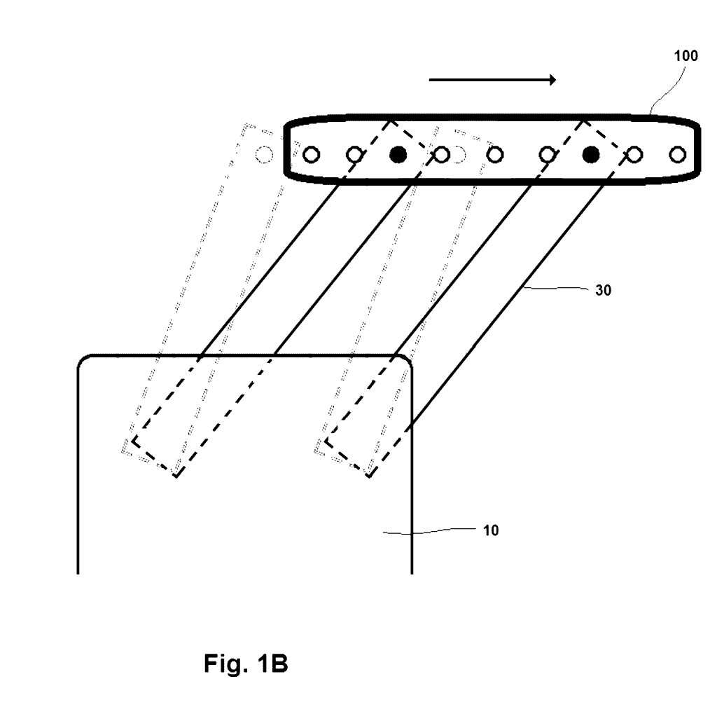

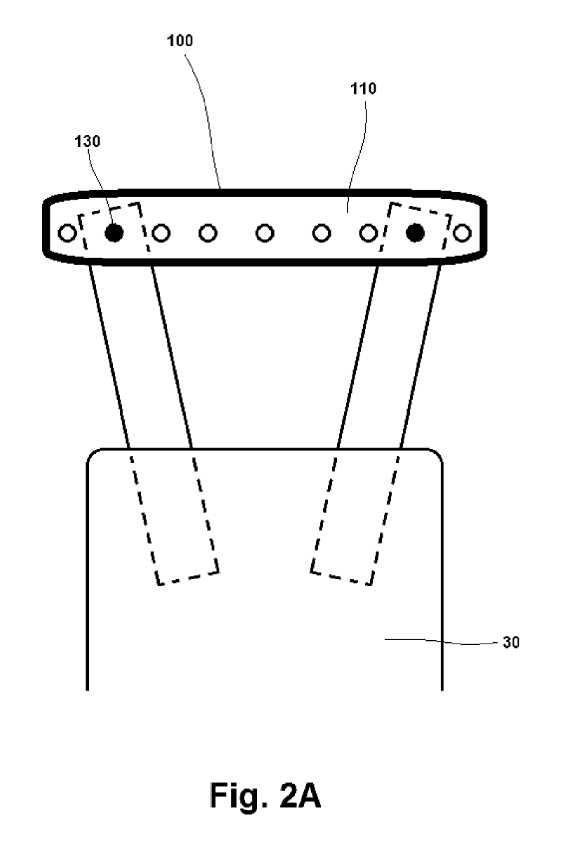

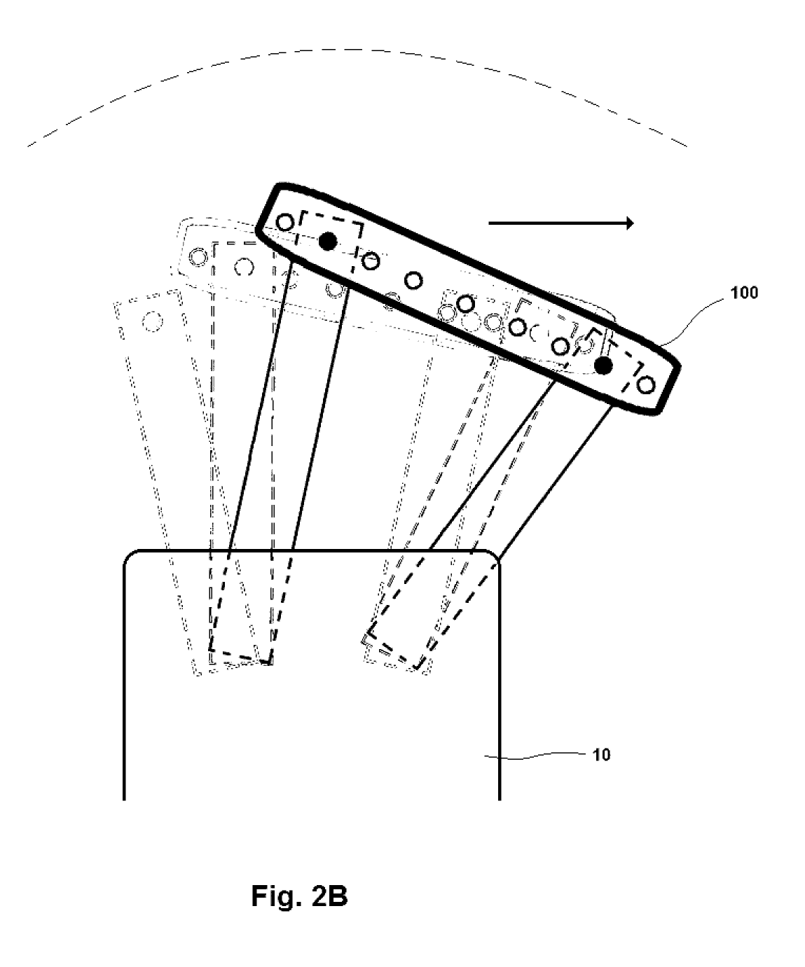

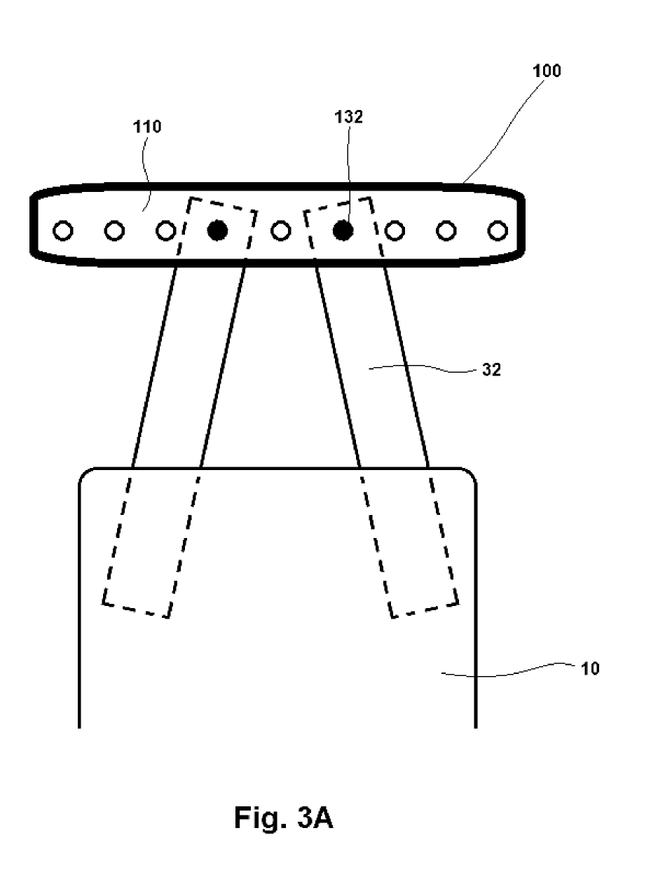

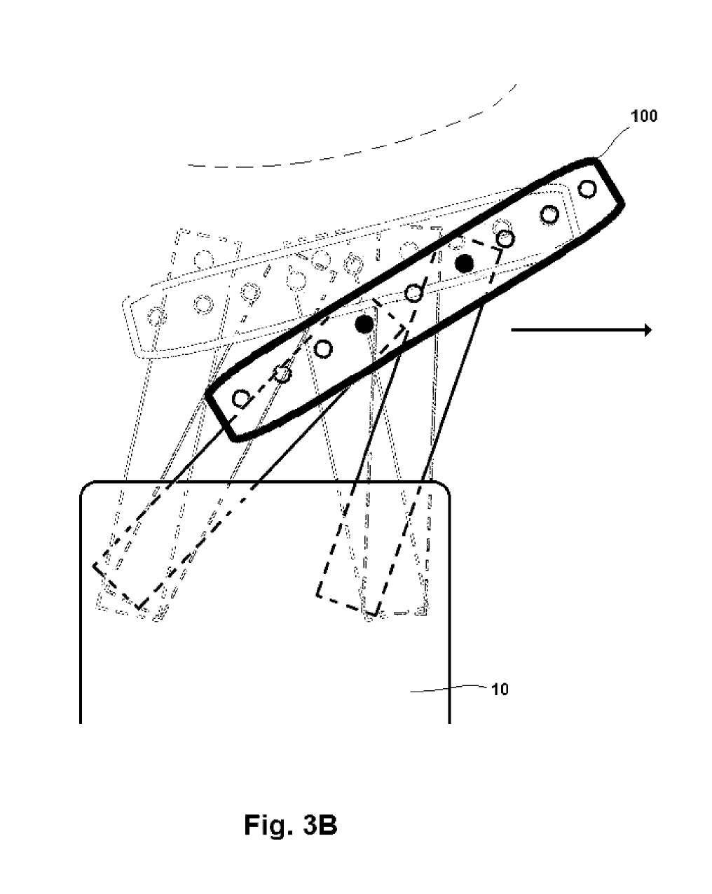

The pair of pivot means 130 of the adapter 100 is adapted to removably connect the support member 110 of the adapter 100 to one of the support arms 32 of the support structure of the two point connection means 30. The pivot means 130 may be any known configuration whereby the adapter 100 is allowed to be in pivotal connection to the support arms 32. Thus, when the support arms 32 are moved laterally by the swing mechanism of the support structure of the two point connection means 30, the orientation of the distal ends of the support arms 32 changes relative to the support member 110 of the adapter 100. See FIGS. 1B, 2B, and 3B. Moreover, because the pivot means 130 are removable, they serve as a quick release of the implement 20 from the two point connection means 30.

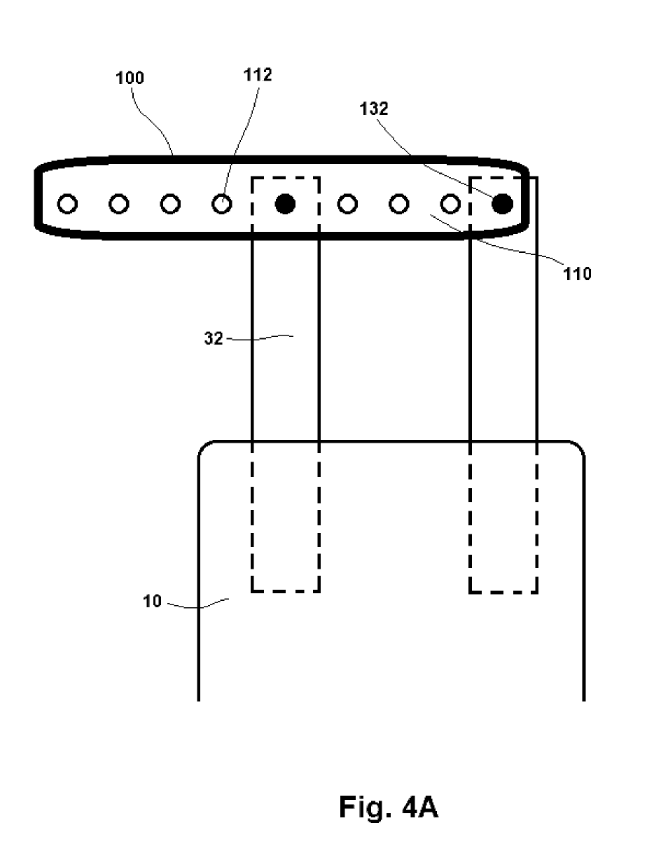

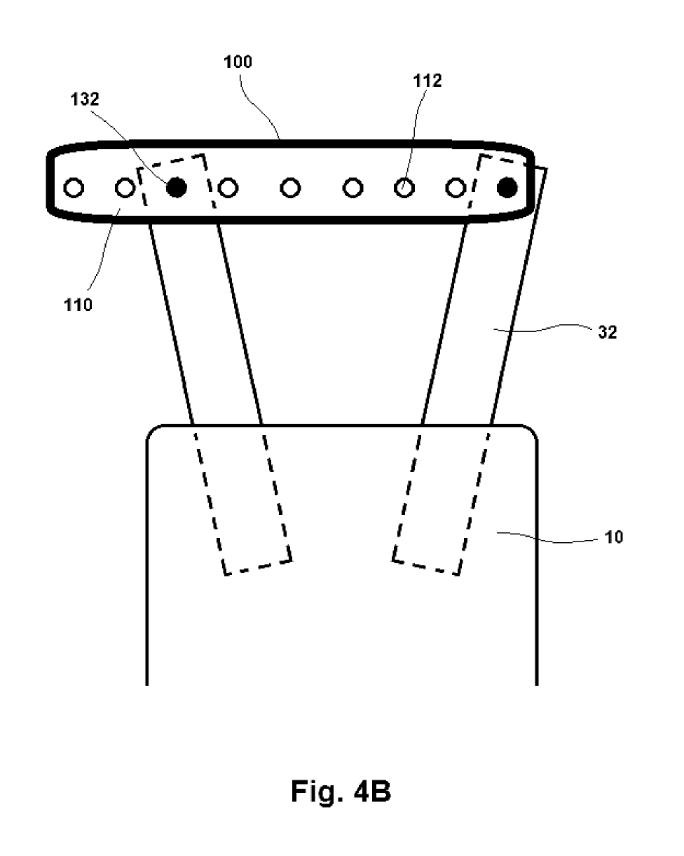

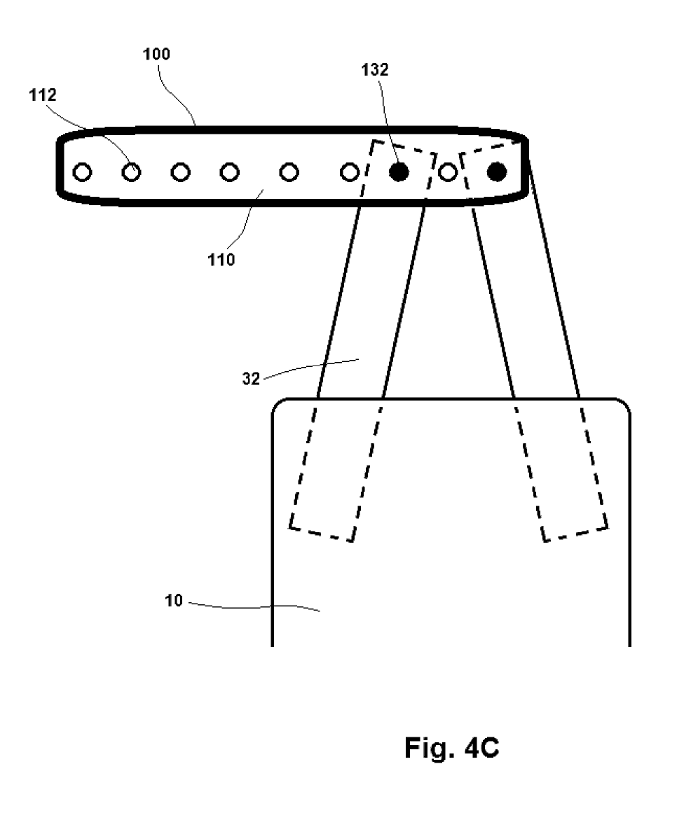

In one embodiment of the present invention, the support member 110 of the adapter 100 comprises three or more apertures 112. In preferred embodiments the support member 110 comprises at least six apertures 112. Each of the pivot means 130 is a pin 132. The pin 132 can have any suitable shape, though in the preferred embodiments it is substantially cylindrical and made of solid construction. In alternative embodiments the pin 132 may be tapered, with one end having a diameter slightly larger than the diameter of the apertures 112 and another end having a diameter slightly smaller than the diameter of the apertures 112. The pins 132 may be made of metal or alloy or any other suitably rigid and strong material. Each pin 132 is suitably adapted to be in connection with the distal end of one of the support arms 32 of the support structure of the two point connection means 30, and is further adapted to be inserted into one of the apertures 112 of the support member 110. In one configuration the pin 132 is fixedly attached to the distal end of the support arm 32, for example, by welds, or threaded into an aperture. In a preferred embodiment there is an aperture formed in the distal end of each support arm 32, and the pin 132 is adapted to be inserted into the aperture. Thus, in this embodiment the pin 132 is simultaneously inserted through the aperture in the support arm 32 and through one of the apertures 112 of the support member 110 of the adapter 100. The pin 132 may be held in place by cotter pins, clevis pins, bolts placed onto threaded ends, or other mechanisms to maintain the pins 132 within the apertures in a manner that allows pivotal movement between the support arms 32 and the support member 110. Depending upon which of the apertures 112 of the support member 110 the pins 132 are inserted into, the geometry of the configuration can be altered as desired. See FIGS. 1A, 2A, 3A, 4A, 4B, and 4C.

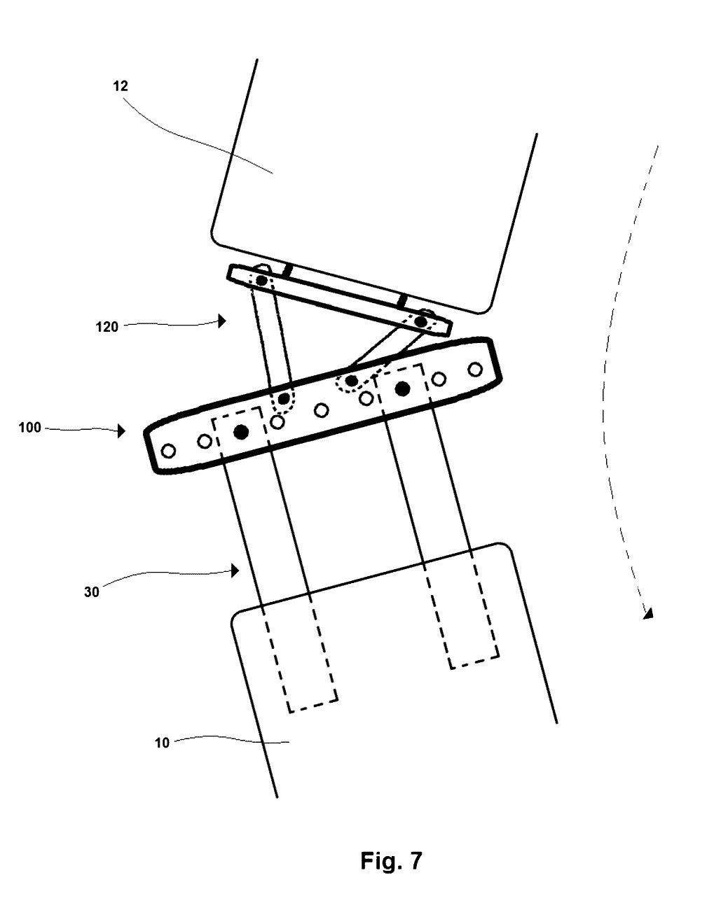

In one embodiment of the present invention, the attachment component 120 of the adapter 100 is suitably adapted to swing laterally freely. This configuration is particularly useful when the two point connection means 30 extends from the rear of the vehicle 10 and the implement 20 is a tow bar. A vehicle 12 attached to the tow bar thus turns freely when the towing vehicle 10 turns corners, making the towing process smoother and safer. See FIG. 7.

In this embodiment the attachment component 120 comprises a pair of pivot arms 140 and a cross piece 150. Each pivot arm 140 is pivotally in connection with the support member 110 of the adapter 100 and is pivotally in connection with the cross piece 150. Each of the pivot arms 140 and the cross piece 150 is a rigid elongate member. The cross piece 150 is further adapted to be in connection with the implement 20. So configured, the cross piece 150 is free to move laterally relative to the support member 110 of the adapter 100.

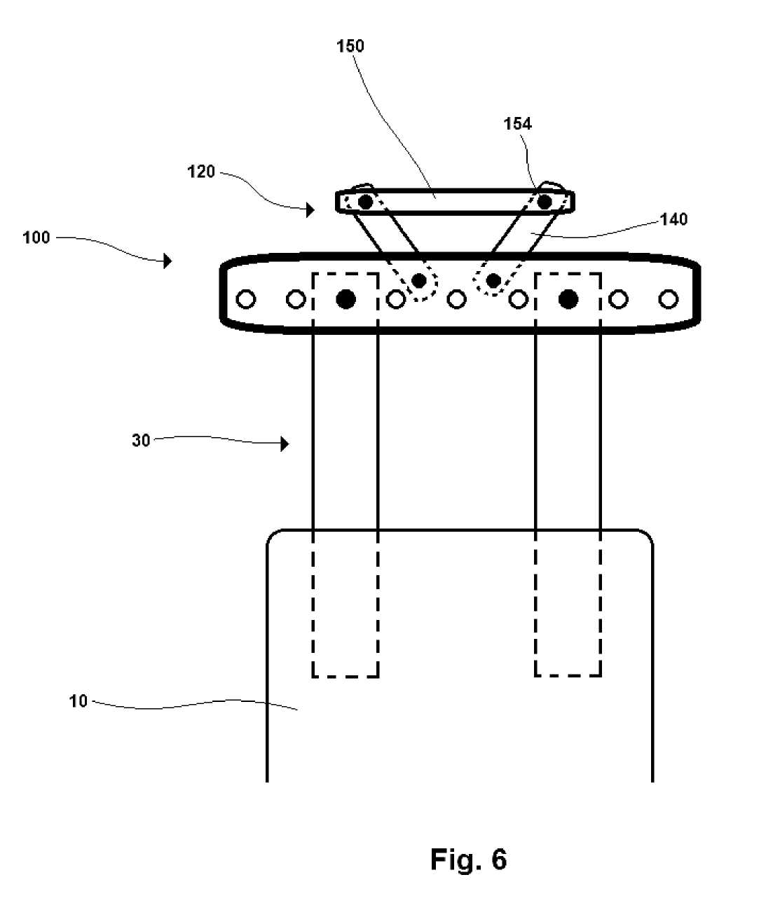

In this embodiment, a pair of pivot apertures 112 are formed into the support member 110 of the adapter 100. Similarly, a pair of pivot apertures is formed into the cross piece 150. Pivot apertures are formed into proximate end of each pivot arm 140 and pivot apertures are formed into the distal end of each pivot arm 140. One pivot aperture 112 of the support member 110 is aligned with the pivot aperture formed into the proximate end of one pivot arm 140 and a pin 154 is inserted therethrough. The other pivot aperture 112 of the support member 110 is aligned with the pivot aperture formed into the proximate end of the other pivot arm 140 and another pin 154 is inserted therethrough. One pivot aperture of the cross piece 150 is aligned with the pivot aperture formed into the distal end of one pivot arm 140 and a third pin 154 is inserted therethrough. The other pivot aperture of the cross piece 150 is aligned with the pivot aperture formed into the distal end of the other pivot arm 140 and a fourth pin 154 is inserted therethrough. See FIG. 6. Each of the four pivot pins 154 is substantially cylindrical and may be secured using cotter pins, clevis pins, threaded bolts, or the like. In alternative embodiments the pins 154 may be tapered, with one end having a diameter slightly larger than the diameter of the pivot apertures and another end having a diameter slightly smaller than the diameter of the pivot apertures.

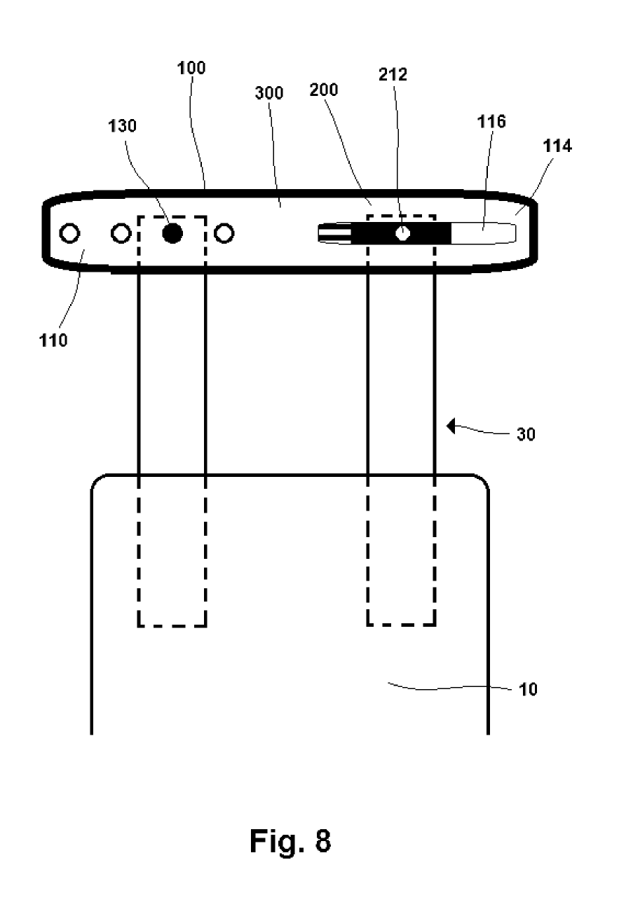

In another embodiment of the present invention, the geometry of the configuration of the two point connection means 30 is altered by means of a movable pivot means 130 within the adapter 100. See FIG. 8. In this embodiment, rather than having a series of discrete apertures positioned along the support member 110, there is a single movable aperture 212 that is positioned as desired. The support member 110 has a top panel 114 and a bottom panel, with a channel formed between those panels. Located within the channel is a slidable aperture member 200. Formed into and through the aperture member 200 is a pivot aperture 212. An elongate slot is 116 is formed in the top panel 114 of the support member 110, and a corresponding slot is formed in the bottom panel of the support member 110. The pivot aperture 212 of the aperture member 200 is aligned with the elongate slots of the support member 110. As described above, a pin 132 is suitably adapted to be inserted into an aperture located at the distal end of one of the support arms 32 of the support structure of the two point connection means 30, and is further adapted to be inserted into the pivot aperture 212 of the aperture member 200. Thus, in this embodiment the pin 132 is simultaneously inserted through the aperture in the support arm 32 and through the pivot aperture 212 of the aperture member 200, with access thereto through the elongate slots formed in the support member 110 of the adapter 100. Also as previously described, the pin 132 may be held in place by cotter pins, clevis pins, bolts placed onto threaded ends, or other mechanisms to maintain the pin 132 within the apertures in a manner that allows pivotal movement between the support arm 32 and the support member 110.

In this embodiment, the aperture member 200 is moved laterally within the channel of the support member 110 by an aperture member movement mechanism 300. See FIG. 8. The aperture member movement mechanism 300 may be hydraulically powered, or may comprise a worm gear, or any other mechanism known in the art that is configured to moved the aperture member 200 laterally as described above, and then to maintain it in place once the desired location is attained. In one variant of this embodiment, only one side of the support member 110 is configured as described, with the other side configured with a plurality of fixed apertures 132 as shown in FIG. 1. In another variant of this embodiment, both sides of the support member 110 are configured as described, with a pair of aperture members 200 and a corresponding pair of aperture member movement mechanisms 300. In this variant, each aperture member 200 may be moved independently of the other.

Modifications and variations can be made to the disclosed embodiments of the present invention without departing from the subject or spirit of the invention as defined in the following claims.

I claim:

1. An adapter to be used with an implement and a two point connection means, said two point connection means being adapted to be attached to the undercarriage of a vehicle and comprising an implement support structure having a pair of support arms extending from the undercarriage of the vehicle, a lift mechanism adapted to raise and lower the support arms, and a swing mechanism adapted to move the support arms laterally, said adapter comprising
a support member,
an attachment component, and
a pair of pivot means;
wherein the support member is substantially rigid and of sufficient structural strength to bear the weight of the implement,
the attachment component is suitably configured to attach the support member of the adapter to the implement, and
each of the pair of pivot means is suitably adapted to removably connect the support member of the adapter to one of the support arms of the support structure of the two point connection means, whereby the adapter is in pivotal connection to said support arms.

2. The adapter of claim 1 wherein
the support member comprises three or more apertures;
each of the support arms of the support structure of the two point connection means comprises an aperture at a distal end; and
each of the pivot means is a pin, whereby each said pin is suitably adapted to be inserted into the aperture of one of the support arms of the support structure of the two point connection means and is suitably adapted to be inserted into one of the three or more apertures of the support member.

3. The adapter of claim 1 wherein
the support member comprises three or more apertures; and
each of the pivot means is a pin, whereby each said pin is suitably adapted to be in connection with one of the support arms of the support structure of the two point connection means and is suitably adapted to be inserted into one of said three or more apertures of the support member.

4. The adapter of claim 1 wherein
each of the support arms of the support structure of the two point connection means comprises an aperture at a distal end; and
each of the pivot means is a pin, whereby each said pin is suitably adapted to be in connection with the support member, extending downward from the support member, and is suitably adapted to be inserted into one of the apertures of the support arms of the support structure of the two point connection means.

5. The adapter of claim 1 wherein
the attachment component of the adapter comprises a pair of pivot arms and a cross piece;
wherein each pivot arm is pivotally in connection with the support member of the adapter and pivotally in connection with the cross piece, and
the cross piece is suitably adapted to be in connection with the implement;
whereby the cross piece is free to move laterally relative to the support member of the adapter.

6. The adapter of claim 5 wherein
the support member of the adapter comprises a pair of pivot apertures and a pair of pivot pins, each said pivot pin suitably adapted to be inserted into one said pivot aperture;
each pivot arm comprises a proximate aperture and a distal aperture, said proximate aperture suitably adapted such that one of the pivot pins of the support member may be inserted into said proximate aperture; and
the cross piece comprises a pair of apertures and a pair of pins, each said pin of the cross piece suitably adapted to be inserted into one of the apertures of the cross piece and suitably adapted to be inserted into the distal aperture of a pivot arm.

7. The adapter of claim 1 wherein
one of the support arms of the support structure of the two point connection means comprises an aperture at a distal end; and
the support member comprises
a top panel, a bottom panel, a channel formed between the top panel and the bottom panel, and a slidable aperture member,
said slidable aperture member located within the channel of the support member and having a pivot aperture formed into and through said aperture member,
said top panel of the support member having a first elongate slot formed therein and oriented substantially laterally, and
said bottom panel of the support member having a second elongate slot formed therein and oriented substantially in alignment with the first elongate slot,
with the pivot aperture of the slidable aperture member aligned with the first and second elongate slots of the support member;
wherein at least one of the pivot means is a pin, whereby said pin is suitably adapted to be inserted into the aperture of the support arm of the support structure of the two point connection means and is suitably adapted to be inserted into the pivot aperture of the slidable aperture member.

8. The adapter of claim 7 further comprising an aperture member movement mechanism, said aperture member movement mechanism being suitably configured to laterally move the aperture member within the channel of the support member and to maintain the aperture member in place within the channel of the support member.

9. The adapter of claim 8 wherein the aperture member movement mechanism is hydraulically powered.

10. The adapter of claim 8 wherein the aperture member movement mechanism comprises a worm gear.
